(19) United States
(12) Patent Application Publication
(10) Pub. No.: US 2026/0117350 A1
(43) Pub. Date: Apr. 30, 2026

(54) Nanocrystalline Alloy Soft Magnetic Powder, Dust Core, Magnetic Element, And Electronic Device

(71) Applicant: SEIKO EPSON CORPORATION, Tokyo (JP)

(72) Inventors: Kohei KASAI, Hachinohe (JP); Mayu WATANABE, Hachinohe (JP); Shiho KAWAHARA, Hachinohe (JP)

(21) Appl. No.: 19/374,320

(22) Filed: Oct. 30, 2025

(30) Foreign Application Priority Data
Oct. 31, 2024 (JP) 2024-191447

(51) Int. Cl. C22C 38/34; B22F 1/05; B22F 1/065; B22F 1/142; B22F 9/00; B22F 9/08; B22F 9/10; C22C 38/00; C22C 38/02; C22C 38/12; C22C 38/16; C22C 38/20; C22C 38/26; C22C 38/32; H01F 1/20; H01F 27/255

(52) U.S. Cl. CPC C22C 38/34; B22F 1/05; B22F 1/065; B22F 1/142; B22F 9/007; B22F 9/082; B22F 9/10; C22C 38/002; C22C 38/02; C22C 38/12; C22C 38/16; C22C 38/20; C22C 38/26; C22C 38/32; H01F 1/20; B22F 2009/0828; B22F 2201/02; B22F 2301/35; B22F 2304/10; B22F 2998/10; B22F 2999/00; C22C 2200/04; C22C 2202/02; H01F 27/255

(57) ABSTRACT

A nanocrystalline alloy soft magnetic powder contains: impurities; and a composition represented by a composition formula FeₐCu_{b}Nb_{c}(Si₁₋ₓ(B_{1-y}Cr_{y})ₓ)_{100-a-b-c-d}S_{d} represented by an atomic ratio, where a, b, c, d, x, and y satisfy 75.5≤a≤79.5, 0.3≤b≤2.0, 2.0≤c≤4.0, 0.001≤d≤0.080, 0.55≤x≤0.91, and 0≤y≤0.185. The nanocrystalline alloy soft magnetic powder has crystal grains having a crystallite diameter of 1.0 nm or more and 30.0 nm or less, a particle diameter D10 is 7.0 μm or more and 15.0 μm or less, and a particle diameter D50 is 22.0 μm or more and 32.0 μm or less.

The present application is based on, and claims priority from JP Application Serial Number 2024-191447, filed Oct. 31, 2024, the disclosure of which is hereby incorporated by reference herein in its entirety.

### BACKGROUND

### 1. Technical Field

The present disclosure relates to a nanocrystalline alloy soft magnetic powder, a dust core, a magnetic element, and an electronic device.

### 2. Related Art

JP-A-2011-023673 discloses an amorphous soft magnetic powder containing S (sulfur) in an amount of 0.01 mass % to 0.2 mass %, in which a composition excluding S is an alloy represented by a formula: (Fe₁₋ₐTMₐ)_{100-w-x-y-z}P_{w}BₓL_{y}Si_{z} (where inevitable impurities are contained, TM is one or more elements selected from Co and Ni, L is one or more elements selected from Al, V, Cr, Y, Zr, Mo, Nb, Ta, and W, 0≤a≤0.98, 2≤w≤16 atomic %, 2≤x≤16 atomic %, 0<y≤10 atomic %, and 0≤z≤8 atomic %). In addition, it is also disclosed that a powder having a representative particle diameter D50 of about 10 μm is obtained by a water atomization method. According to such a configuration, it is possible to provide an amorphous soft magnetic powder having good magnetic properties and capable of being molded at a low pressure and a high density.

JP-A-2011-023673 is an example of the related art.

However, in the amorphous soft magnetic powder described in JP-A-2011-023673, a particle size distribution is positioned on a small diameter side, and there is a difficulty in filling properties. Therefore, the amorphous soft magnetic powder described in JP-A-2011-023673 still has room for improvement from the viewpoint of enhancing the filling properties.

Therefore, there is a demand for a nanocrystalline alloy soft magnetic powder having an optimized particle shape and particle size distribution and exhibiting good filling properties and magnetic properties.

### SUMMARY

A nanocrystalline alloy soft magnetic powder according to an application example of the present disclosure contains:
impurities; and
a composition represented by a composition formula FeₐCu_{b}Nb_{c}(Si₁₋ₓ(B_{1-y}Cr_{y})ₓ)_{100-a-b-c-d}S_{d} represented by an atomic ratio, where a, b, c, d, x, and y satisfy 75.5≤a≤79.5, 0.3≤b≤2.0, 2.0≤c≤4.0, 0.001≤d≤0.080, 0.55≤x≤0.91, and 0≤y≤0.185,
the nanocrystalline alloy soft magnetic powder has crystal grains having a crystallite diameter of 1.0 nm or more and 30.0 nm or less measured by an X-ray diffraction method, and
in a volume-based cumulative particle size distribution obtained using a laser diffraction type particle size distribution measurement device, when D10 is a particle diameter at which a cumulative frequency is 10% from a small diameter side and D50 is a particle diameter at which a cumulative frequency is 50% from the small diameter side,
the particle diameter D10 is 7.0 μm or more and 15.0 μm or less, and
the particle diameter D50 is 22.0 μm or more and 32.0 μm or less.

A dust core according to an application example of the present disclosure includes:
the nanocrystalline alloy soft magnetic powder according to the application example of the present disclosure.

A magnetic element according to an application example of the present disclosure includes:
the dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a plan view schematically showing a coil component of a toroidal type.

FIG. 2 is a transparent perspective view schematically showing a coil component of a closed magnetic circuit type.

FIG. 3 is a perspective view showing a mobile personal computer which is an electronic device according to an embodiment.

FIG. 4 is a plan view showing a smartphone which is an electronic device according to the embodiment.

FIG. 5 is a perspective view showing a digital still camera which is the electronic device according to the embodiment.

FIG. 6 is Table 1 showing configurations of nanocrystalline alloy soft magnetic powders in sample Nos. 1 to 15.

FIG. 7 is Table 2 showing configurations of the nanocrystalline alloy soft magnetic powders in sample Nos. 16 to 30.

FIG. 8 is Table 3 showing evaluation results of the nanocrystalline alloy soft magnetic powders in sample Nos. 1 to 15.

FIG. 9 is Table 4 showing the evaluation results of the nanocrystalline alloy soft magnetic powders in sample Nos. 16 to 30.

### DESCRIPTION OF EMBODIMENTS

Hereinafter, a nanocrystalline alloy soft magnetic powder, a dust core, a magnetic element, and an electronic device according to the present disclosure will be described in detail based on a preferred embodiment shown in the accompanying drawings.

### 1. Nanocrystalline Alloy Soft Magnetic Powder

A nanocrystalline alloy soft magnetic powder according to an embodiment is a metal powder exhibiting soft magnetism. The nanocrystalline alloy soft magnetic powder can be applied to various uses, for example, production of various green compacts such as a dust core and an electromagnetic wave absorber by binding particles together with a binder.

The nanocrystalline alloy soft magnetic powder according to the embodiment is formed of impurities and a composition represented by a composition formula FeₐCu_{b}Nb_{c}(Si₁₋ₓ(B_{1-y}Cr_{y})ₓ)_{100-a-b-c-d}S_{d} in terms of atomic ratio, where [a, b, c, d, x, and y satisfy 75.5≤a≤79.5, 0.3≤b≤2.0, 2.0≤c≤4.0, 0.001≤d≤0.080, 0.55≤x≤0.91, and 0≤y≤0.185].

In addition, the nanocrystalline alloy soft magnetic powder according to the embodiment has a crystallite diameter measured by an X-ray diffraction method of 1.0 nm or more and 30.0 nm or less, and contains fine crystals having a crystallite diameter of a so-called nano-order.

Further, in the nanocrystalline alloy soft magnetic powder according to the embodiment, in a volume-based cumulative particle size distribution acquired using a laser diffraction type particle size distribution measurement device, when a particle diameter D10 is a particle diameter at which a cumulative frequency is 10% from a small diameter side and a particle diameter D50 is a particle diameter at which the cumulative frequency is 50% from the small diameter side, the particle diameter D10 is 7.0 μm or more and 15.0 μm or less, and the particle diameter D50 is 22.0 μm or more and 32.0 μm or less.

Since such a nanocrystalline alloy soft magnetic powder contains an optimum amount of S (sulfur), a particle shape and a particle size distribution are optimized. Accordingly, a nanocrystalline alloy soft magnetic powder exhibiting good filling properties is obtained. In addition, in the nanocrystalline alloy soft magnetic powder, since a content of each element is optimized, and the crystallite diameter, the particle diameter D10, and the particle diameter D50 are optimized, good magnetic properties such as a low coercive force and high permeability are secured. Therefore, by containing such a nanocrystalline alloy soft magnetic powder, a dust core capable of implementing a magnetic element having high permeability and low iron loss is obtained.

Hereinafter, the nanocrystalline alloy soft magnetic powder according to the embodiment will be described in detail.

### 1.1. Composition

Fe (iron) greatly affects basic magnetic properties and mechanical properties of the nanocrystalline alloy soft magnetic powder according to the embodiment.

A content a of Fe is 75.5 atomic % or more and 79.5 atomic % or less, preferably 76.0 atomic % or more and 79.0 atomic % or less, and more preferably 76.5 atomic % or more and 78.5 atomic % or less. When the content a of Fe is less than the lower limit value, a saturation magnetic flux density and the permeability of the nanocrystalline alloy soft magnetic powder decrease. On the other hand, when the content a of Fe is more than the upper limit value, an amorphous structure cannot be stably formed during production of the nanocrystalline alloy soft magnetic powder, resulting in an excessively large crystallite diameter and an increase in coercive force.

When the nanocrystalline alloy soft magnetic powder according to the embodiment is produced from raw materials, Cu (copper) tends to separate from Fe. Therefore, the containing of Cu causes a fluctuation in the composition, resulting in regions within the particles that are likely to be crystallized. As a result, precipitation of an Fe phase of a body-centered cubic lattice which is crystallized with relative ease is promoted, and crystal grains having the above-described crystallite diameter tend to be formed.

A content b of Cu is 0.3 atomic % or more and 2.0 atomic % or less, preferably 0.5 atomic % or more and 1.5 atomic % or less, and more preferably 0.7 atomic % or more and 1.3 atomic % or less. When the content b of Cu is less than the lower limit value, the refinement of crystal grains is impaired, and the crystal grains having the crystallite diameter within the above-described range cannot be formed. On the other hand, when the content b of Cu is more than the upper limit value, the mechanical properties of the nanocrystalline alloy soft magnetic powder decrease, and the nanocrystalline alloy soft magnetic powder becomes brittle.

When a material containing a large amount of amorphous structure is subjected to a heat treatment, Nb (niobium) contributes to the refinement of the crystal grains together with Cu. Therefore, the crystal grains having the above-described crystallite diameter are easily formed.

A content c of Nb is 2.0 atomic % or more and 4.0 atomic % or less, preferably 2.5 atomic % or more and 3.5 atomic % or less, and more preferably 2.7 atomic % or more and 3.3 atomic % or less. When the content c of Nb is less than the lower limit value, the refinement of crystal grains is impaired, and the crystal grains having the crystallite diameter within the above-described range cannot be formed. On the other hand, when the content c of Nb is more than the upper limit value, the mechanical properties of the nanocrystalline alloy soft magnetic powder decrease, and the nanocrystalline alloy soft magnetic powder becomes brittle. In addition, the permeability of the nanocrystalline alloy soft magnetic powder decreases.

Silicon (Si) promotes amorphization when the nanocrystalline alloy soft magnetic powder according to the embodiment is produced from a raw material. Therefore, when the nanocrystalline alloy soft magnetic powder according to the embodiment is produced, a homogeneous amorphous structure is first formed, and then, by crystallizing the amorphous structure, crystal grains having a more uniform crystallite diameter are easily formed. The uniform crystallite diameter contributes to averaging out magnetocrystalline anisotropy in each of crystal grains, thereby reducing the coercive force and enhancing the permeability, which contributes to improving the soft magnetism.

B (boron) promotes the amorphization when the nanocrystalline alloy soft magnetic powder according to the embodiment is produced from a raw material. Therefore, when the nanocrystalline alloy soft magnetic powder according to the embodiment is produced, a homogeneous amorphous structure is first formed, and then, by crystallizing the amorphous structure, crystal grains having a more uniform crystallite diameter are easily formed. As a result, the coercive force can be reduced, the permeability can be enhanced, and the soft magnetism can be improved. In addition, by using Si and B in combination, the amorphization can be synergistically promoted based on a difference in an atomic radius between Si and B.

Cr (chromium) enhances an oxidation resistance of the nanocrystalline alloy soft magnetic powder. Accordingly, when the nanocrystalline alloy soft magnetic powder is compacted, it is possible to prevent a decrease in a density of the green compact caused by the oxide. As a result, the effect of oxides on magnetic properties can be reduced. In addition, by optimizing a content of Cr, the crystallite diameter in the nanocrystalline alloy soft magnetic powder can be controlled so as not to be too small or too large. As a result, an increase in the coercive force of the nanocrystalline alloy soft magnetic powder can be prevented.

A total content of Si, B, and Cr, which is (Si+B+Cr), is set to 1, and a ratio of the total content (B+Cr) of B and Cr to the total content (Si+B+Cr) is set to x.

x satisfies 0.55≤x≤0.91, preferably satisfies 0.60≤x≤0.90, and more preferably satisfies 0.65≤x≤0.80. Accordingly, a quantitative balance between Si and B and Cr can be achieved. As a result, it is possible to enhance both the oxidation resistance and the permeability of the nanocrystalline alloy soft magnetic powder in a well-balanced manner.

When x is less than the lower limit value, the oxidation resistance decreases, and the crystallite diameter becomes too small, resulting in a decrease in permeability. On the other hand, when x is more than the upper limit value, the crystallite diameter becomes too large, resulting in an increase in coercive force.

The ratio of the content of Cr to the total content (B+Cr) is defined as y.

y satisfies 0≤y≤0.185, preferably satisfies 0.020≤y≤0.150, and more preferably satisfies 0.045≤y≤0.120. Accordingly, a quantitative balance between B and Cr can be achieved. As a result, it is possible to enhance both the oxidation resistance and the permeability of the nanocrystalline alloy soft magnetic powder in a well-balanced manner.

Although y may be less than the lower limit value, the oxidation resistance may decrease depending on an overall composition. On the other hand, when y is more than the upper limit value, the crystallite diameter becomes too large, resulting in an increase in coercive force.

A content of Si is preferably 1.5 atomic % or more and 14.0 atomic % or less, more preferably 3.0 atomic % or more and 10.0 atomic % or less, and further preferably 4.0 atomic % or more and 8.0 atomic % or less. Accordingly, it is possible to obtain a nanocrystalline alloy soft magnetic powder that can be used to produce a green compact having a lower coercive force and better DC superimposition characteristics.

A content of B is preferably 5.0 atomic % or more and 17.0 atomic % or less, more preferably 7.0 atomic % or more and 16.0 atomic % or less, and further preferably 9.0 atomic % or more and 14.0 atomic % or less. Accordingly, it is possible to obtain a nanocrystalline alloy soft magnetic powder that can be used to produce a green compact having a lower coercive force and better DC superimposition characteristics.

The content of Cr is preferably 0 atomic % or more and 2.7 atomic % or less, more preferably 0.5 atomic % or more and 2.2 atomic % or less, and further preferably 0.8 atomic % or more and 1.8 atomic % or less. Accordingly, it is possible to further enhance the oxidation resistance of the nanocrystalline alloy soft magnetic powder and further inhibit the generation of oxides. As a result, the crystallite diameter of the crystal grains contained in each particle can be appropriately controlled.

The nanocrystalline alloy soft magnetic powder according to the embodiment may contain impurities in addition to the composition represented by a composition formula FeₐCu_{b}Nb_{c}(Si₁₋ₓ(B_{1-y}Cr_{y})ₓ)_{100-a-b-c-d}S_{d}) Examples of the impurities include all elements other than those described above, and a total content of impurities is preferably 0.50 atomic % or less. As long as the content is within the above range, the impurities are less likely to hinder the effect even when the impurities are mixed in, and thus the impurities are allowed to be contained.

The content of each element contained in the impurities is preferably 0.05 atomic % or less. As long as the content is within the above range, the impurities are less likely to hinder the effect, and thus the impurities are allowed to be contained.

In addition, among the impurities, particularly, an oxygen content of the nanocrystalline alloy soft magnetic powder is preferably 800 ppm or more and 3000 ppm or less, more preferably 900 ppm or more and 2000 ppm or less, and still more preferably 1000 ppm or more and 1500 ppm or less. When the oxygen content is within the above range, the formation of an oxide that causes a decrease in a density of a molded body can be particularly reduced to a low level, and insulating properties between particles associated with the oxide can be secured to some extent.

When the oxygen content of the nanocrystalline alloy soft magnetic powder is less than the lower limit value, the insulating properties between particles decrease, and an eddy current between the particles is likely to be generated, so that the iron loss of the dust core may increase. On the other hand, when the oxygen content of the nanocrystalline alloy soft magnetic powder is more than the above upper limit value, the density of the green compact may decrease, and the magnetic properties of the dust core may decrease.

Although the nanocrystalline alloy soft magnetic powder according to the embodiment is described, the composition and the impurities are identified by the following analysis method.

Examples of the analysis method include an iron and steel-atomic absorption spectrometric method defined in JIS G 1257:2000, an iron and steel-ICP emission spectrometric method defined in JIS G 1258:2007, an iron and steel-method for spark discharge optical emission spectrometric analysis defined in JIS G 1253:2002, an iron and steel-method for x-ray fluorescence spectrometric analysis defined in JIS G 1256:1997, and gravimetric, titration and absorption spectrometric methods defined in JIS G 1211 to JIS G 1237.

Specific examples include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur (S), an infrared absorption method after combustion in a current of oxygen (combustion in high frequency induction furnace) defined in JIS G 1211:2011 is also used. Specifically, an example thereof is a carbon and sulfur analyzer CS-200 manufactured by LECO Corporation.

When nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen/nitrogen analyzer TC-300/EF-300 manufactured by LECO Corporation, and an oxygen/nitrogen/hydrogen analyzer ONH836 manufactured by LECO Corporation.

### 1.2. Particle Diameter

The particle diameter D10 of the nanocrystalline alloy soft magnetic powder according to the embodiment is 7.0 μm or more and 15.0 μm or less, preferably 8.0 μm or more and 14.0 μm or less, and more preferably 9.0 μm or more and 13.0 μm or less.

When the particle diameter D10 of the nanocrystalline alloy soft magnetic powder is within the above range, the particle size distribution can be optimized, and thus a nanocrystalline alloy soft magnetic powder having high fluidity and filling properties can be obtained. Accordingly, it is likely to enhance the permeability and saturation magnetic flux density of the dust core.

When the particle diameter D10 of the nanocrystalline alloy soft magnetic powder is less than the lower limit value, the nanocrystalline alloy soft magnetic powder is too fine, and thus the filling property of the nanocrystalline alloy soft magnetic powder is likely to decrease. Accordingly, a molding density of the dust core, which may result in a decrease in the permeability and the saturation magnetic flux density of the dust core depending on the composition and mechanical properties of the nanocrystalline alloy soft magnetic powder, may decrease. On the other hand, when an average particle diameter of the nanocrystalline alloy soft magnetic powder is more than the above upper limit value, the number of particles filling gaps between the particles decreases, and the molding density of the dust core may decrease.

The particle diameter D50 of the nanocrystalline alloy soft magnetic powder according to the embodiment is 22.0 μm or more and 32.0 μm or less, preferably 23.0 μm or more and 31.0 μm or less, and more preferably 25.0 μm or more and 30.0 μm or less.

When the particle diameter D50 of the nanocrystalline alloy soft magnetic powder is within the above range, the particle size distribution can be optimized, and thus a nanocrystalline alloy soft magnetic powder having high fluidity and filling properties can be obtained. Accordingly, it is likely to enhance the permeability and saturation magnetic flux density of the dust core. In addition, an eddy current loss generated in the particles is reduced, and the iron loss of the magnetic element is reduced.

When the particle diameter D50 of the nanocrystalline alloy soft magnetic powder is less than the lower limit value, the nanocrystalline alloy soft magnetic powder is too fine, and thus the filling property of the nanocrystalline alloy soft magnetic powder is likely to decrease. Accordingly, a molding density of the dust core, which may result in a decrease in the permeability and the saturation magnetic flux density of the dust core depending on the composition and mechanical properties of the nanocrystalline alloy soft magnetic powder, may decrease. On the other hand, when the average particle diameter of the nanocrystalline alloy soft magnetic powder is more than the upper limit value, the eddy current loss generated within the particles may not be sufficiently reduced, and the iron loss of the magnetic element may increase.

In addition, for the nanocrystalline alloy soft magnetic powder according to the embodiment, in the volume-based cumulative particle size distribution acquired using the laser diffraction type particle size distribution measurement device, the particle diameter at which the cumulative frequency is 90% from the small diameter side is defined as D90.

A ratio of the particle diameter D10 to the particle diameter D90 of the nanocrystalline alloy soft magnetic powder according to the embodiment is defined as a particle diameter ratio D10/D90. The particle diameter ratio D10/D90 is preferably 0.180 or more and 0.220 or less, and more preferably 0.190 or more and 0.210 or less. When the particle diameter ratio D10/D90 is within the above range, the particle size distribution can be optimized, and thus a nanocrystalline alloy soft magnetic powder having high fluidity and filling properties can be obtained. Accordingly, it is likely to enhance the permeability and saturation magnetic flux density of the dust core.

When the particle diameter ratio D10/D90 of the nanocrystalline alloy soft magnetic powder is less than the lower limit value, fine particles are generated, and thus the fluidity and the filling property of the nanocrystalline alloy soft magnetic powder may be reduced. On the other hand, when the particle diameter ratio D10/D90 of the nanocrystalline alloy soft magnetic powder is more than the upper limit value, the number of particles filling the gaps between the particles decreases, and the molding density of the dust core may decrease.

### 1.3. Crystallite Diameter

The nanocrystalline alloy soft magnetic powder according to the embodiment has a crystallite diameter of 1.0 nm or more and 30.0 nm or less as measured by an X-ray diffraction method. When the crystallite diameter is within such a range, since the crystallite diameter of the nanocrystalline alloy soft magnetic powder is optimized, the magnetocrystalline anisotropy in each crystallite is easily averaged, and a nanocrystalline alloy soft magnetic powder having both low coercive force and ease of production is obtained. Further, it is possible to implement a nanocrystalline alloy soft magnetic powder having stable permeability over a wide frequency range. Accordingly, since the magnetic saturation is less likely to occur, it is possible to obtain a nanocrystalline alloy soft magnetic powder that can implement a magnetic element having good DC superimposition characteristics and excellent operational stability.

The crystallite diameter of the nanocrystalline alloy soft magnetic powder is preferably 3.0 nm or more and 20.0 nm or less, and more preferably 6.0 nm or more and 15.0 nm or less.

The measurement of the crystallite diameter by the X-ray diffraction method is performed by a method in which an X-ray diffraction pattern is obtained for each of the nanocrystalline alloy soft magnetic powder and a standard sample, the diffraction line width derived from Fe is estimated, and then the crystallite diameter is calculated by the Scherrer method. The X-ray diffraction pattern obtained for the standard sample is used to estimate the diffraction line width derived from a device. The crystallite diameter calculated based on the nanocrystalline alloy soft magnetic powder can be corrected by the diffraction line width acquired from the standard sample.

Each particle constituting the nanocrystalline alloy soft magnetic powder according to the embodiment contains crystal grains satisfying the above-described crystallite diameter, but may further contain an amorphous structure. Coexistence of the crystal grains and the amorphous structure can reduce a magnetostriction of the nanocrystalline alloy soft magnetic powder. As a result, a nanocrystalline alloy soft magnetic powder whose permeability is less likely to decrease is obtained.

When the crystallite diameter of the nanocrystalline alloy soft magnetic powder is less than the lower limit value, production difficulty for the nanocrystalline alloy soft magnetic powder may increase. On the other hand, when the crystallite diameter of the nanocrystalline alloy soft magnetic powder is more than the upper limit value, the coercive force may decrease and the magnetic properties may decrease.

### 1.4. Mass Ratio

When the nanocrystalline alloy soft magnetic powder according to the embodiment is classified by the following procedure, a mass ratio of an obtained classified product preferably satisfies a predetermined condition.

First, the nanocrystalline alloy soft magnetic powder is classified with a first sieve having an opening of 53 μm. The classified product that passes through the first sieve is referred to as −53 particles. Next, the −53 particles are classified with a second sieve having an opening of 25 μm. The classified product that passes through the second sieve is −25 particles.

In the nanocrystalline alloy soft magnetic powder, the mass ratio of the −25 particles to the −53 particles is preferably 40% or more and 65% or less, more preferably 45% or more and 63% or less, and further preferably 50% or more and 61% or less. Accordingly, it is possible to optimize the mass ratio of particles with a particle diameter of 25 μm interposed therebetween, thereby further optimizing the particle size distribution. As a result, a nanocrystalline alloy soft magnetic powder having particularly high fluidity and filling properties is obtained.

### 1.5. Average Circularity

An average circularity of the nanocrystalline alloy soft magnetic powder according to the embodiment is preferably 0.85 or more and less than 1.00, more preferably 0.87 or more and 0.97 or less, and further preferably 0.89 or more and 0.95 or less. Accordingly, since the particles are spheroidized, a filling state can be brought close to closest packing, and the ease of production can be enhanced.

When the average circularity is less than the lower limit value, the fluidity and filling property of the particles of the nanocrystalline alloy soft magnetic powder may decrease. On the other hand, when the average circularity is more than the above upper limit value, the production difficulty increases, and production efficiency of the nanocrystalline alloy soft magnetic powder may decrease.

The average circularity of the nanocrystalline alloy soft magnetic powder is measured as follows.

First, an image (secondary electron image) of the nanocrystalline alloy soft magnetic powder is captured with a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 to 100 particles appear in one image. Then, a plurality of images are acquired to obtain images of a total of 300 or more particles.

Next, a circularity of the images of 300 or more particles is calculated using software, and an average value is obtained. The obtained average value is the average circularity of the nanocrystalline alloy soft magnetic powder. When a circularity is represented by e, an area of a particle image is represented by S, and a perimeter of the particle image is represented by L, the circularity e is obtained using the following formula.

$$e = 4 π S / {L}^{2}$$

### 1.6. Tap Density

Specifically, a tap density of the nanocrystalline alloy soft magnetic powder according to the embodiment is preferably 4.90 g/cm³ or more and 5.20 g/cm³ or less, and more preferably 4.90 g/cm³ or more and 5.10 g/cm³ or less. When the tap density is within the above range, a nanocrystalline alloy soft magnetic powder having particularly high fluidity and filling properties is obtained.

When the tap density is less than the lower limit value, when the nanocrystalline alloy soft magnetic powder is compacted to obtain a dust core, the filling properties of the nanocrystalline alloy soft magnetic powder may decrease. On the other hand, when the tap density is more than the above upper limit value, production difficulty of the nanocrystalline alloy soft magnetic powder increases, and a production yield may decrease.

The tap density of the nanocrystalline alloy soft magnetic powder is measured according to a metal powder-tap density measurement method specified in JIS Z 2512:2012.

### 1.7. Permeability

When the permeability of the nanocrystalline alloy soft magnetic powder according to the embodiment is measured at a frequency of 1 MHz after a test object described later is produced, the measured permeability is preferably 22 or more, and more preferably 24 or more and 40 or less.

According to such a configuration, a nanocrystalline alloy soft magnetic powder capable of producing a magnetic element having high permeability is obtained.

A method for producing the test object and a method for measuring the permeability are as follows.

First, an epoxy resin in an amount equivalent to 2.0 mass % of the nanocrystalline alloy soft magnetic powder is mixed with the nanocrystalline alloy soft magnetic powder, and the obtained mixture is press-molded at a pressure of 294.2 MPa (3 t/cm²). Accordingly, the test object is obtained which is in a shape of a ring having an outer diameter of 14 mm, an inner diameter of 8 mm, a thickness of 3 mm and a relative density of 66%. The relative density is a relative value obtained by dividing the density, which is calculated by dividing a mass of the test object by the volume, by a true density of the nanocrystalline alloy soft magnetic powder. Next, a conductive wire having a wire diameter of 0.6 mm is wound around the obtained test object seven times. Next, a permeability of the test object is measured at a frequency of 1 MHz. For the measurement of the permeability, an impedance analyzer such as the 4194A manufactured by Agilent Technologies, Inc. is used.

### 1.8. Iron Loss

In the nanocrystalline alloy soft magnetic powder according to the embodiment, when iron loss is measured after a test object described later is produced, the measured iron loss is preferably 1500 kW/m³ or less, and more preferably 1000 kW/m³ or less. Accordingly, a nanocrystalline alloy soft magnetic powder applicable to a power-saving electronic device or the like can be implemented.

A method for producing the test object and a method for measuring the iron loss are as follows.

First, an epoxy resin in an amount equivalent to 2.0 mass % of the nanocrystalline alloy soft magnetic powder is mixed with the nanocrystalline alloy soft magnetic powder, and the obtained mixture is press-molded at a pressure of 49.0 MPa (0.5 t/cm²). Accordingly, a ring-shaped green compact having an outer diameter of 14 mm, an inner diameter of 8 mm, and a thickness of 3 mm is obtained. Next, a conductive wire having a wire diameter of 0.16 mm is wound around the obtained green compact in 18 turns on a primary side and 18 turns on a secondary side to obtain a test object. A constituent material of the conductive wire is Cu. Next, the iron loss of the obtained test object is measured. An iron loss measurement device is a BH analyzer SY-8218 manufactured by Iwasaki Electric Co., Ltd., an iron loss measurement frequency is 1 MHz, and a maximum magnetic flux density during iron loss measurement is 20 mT.

A ratio D10/Pi of the particle diameter D10 to an iron loss Pi is preferably 0.0011 (μm·kW)/m³ or more and 0.0020 (μm·kW)/m³ or less, more preferably 0.0012 (μm·kW)/m³ or more and 0.0019 (μm·kW)/m³ or less, and further preferably 0.0013 (μm·kW)/m³ or more and 0.0018 (μm·kW)/m³ or less.

According to such a configuration, since the ratio D10/Pi of the particle diameter D10 to the iron loss Pi is optimized, a nanocrystalline alloy soft magnetic powder capable of implementing a magnetic element having a high molding density of the dust core and a low iron loss is obtained.

### 2. Method for Producing Nanocrystalline Alloy Soft Magnetic Powder

Next, an example of a method for producing the nanocrystalline alloy soft magnetic powder according to the embodiment will be described.

The nanocrystalline alloy soft magnetic powder is produced, for example, by producing a metal powder and then performing a crystallization treatment (heat treatment).

Examples of the method for producing the metal powder include a pulverization method, in addition to various atomization methods such as a water atomization method, a rotary water jet atomization method, and a gas atomization method. Among these, the atomization method is preferably used.

The atomization method is a method for producing a metal powder by causing a molten metal to collide with a liquid or a gas sprayed at a high speed so as to pulverize and cool the molten metal.

Among these, the water atomization method is a method for producing a metal powder from a molten metal by using a liquid such as water as a coolant, spraying the liquid in an inverted conical shape to converge the liquid to one point, and causing the molten metal to flow down toward the convergence point and to undergo collision.

The rotary water jet atomization method is a method for producing a metal powder by supplying a coolant along an inner peripheral surface of a cooling cylinder, swirling the coolant along the inner peripheral surface, spraying a jet of a liquid or a gas to a molten metal, and merging the scattered molten metal into the coolant.

The gas atomization method is a method for producing a metal powder from a molten metal by using a gas as a cooling medium, injecting the gas in an inverted conical shape that converges the gas to one point, and causing the molten metal to flow down toward the convergence point and undergo collision.

The produced metal powder may be subjected to a classification process as necessary. Examples of the classification process include dry classification such as sieving classification, inertial classification, centrifugal classification, and air classification, and wet classification such as sedimentation classification.

Each of the particles of the metal powder obtained in such a manner has an amorphous structure. By subjecting such a metal powder to a crystallization treatment (heat treatment) to be described later, a nanocrystalline alloy soft magnetic powder is obtained.

A temperature of the heat treatment is preferably 420° C. or higher and 620° C. or lower, more preferably 470° C. or higher and 610° C. or lower, and further preferably 500° C. or higher and 600° C. or lower. When the temperature of the heat treatment is within the above range, a stress strain can be sufficiently relaxed while appropriately crystallizing the amorphous structure.

A time for maintaining the temperature in the heat treatment (heat treatment time) is preferably 5 minutes or more and 60 minutes or less, more preferably 7 minutes or more and 45 minutes or less, and further preferably 10 minutes or more and 30 minutes or less. When the heat treatment time is within the above range, the amorphous structure can be appropriately crystallized, and the stress strain can be sufficiently relaxed.

The heat treatment is performed using, for example, a heat treatment furnace. A pressure in the heat treatment furnace may be an atmospheric pressure, a negative pressure, or a positive pressure. Among these, the positive pressure is preferable. By performing the heat treatment under the positive pressure in the heat treatment furnace, a thermal conductivity of surroundings of the metal powder in the heat treatment furnace can be enhanced. Accordingly, the temperature of the metal powder is uniformly increased to every corner, a variation in crystallite diameter of the nanocrystals can be reduced as a whole of the produced nanocrystalline alloy soft magnetic powder, and the coercive force can be further reduced.

The pressure in the heat treatment furnace is preferably 5 Pa or more and 1000 Pa or less, more preferably 10 Pa or more and 700 Pa or less, and still more preferably 30 Pa or more and 500 Pa or less.

When the pressure in the heat treatment furnace is less than the lower limit value, the temperature and the like of the heat treatment are likely to vary for each particle, and the heat treatment may be insufficient or excessive in a part. On the other hand, when the pressure in the heat treatment furnace is more than the upper limit value, further effects cannot be expected, and energy efficiency of the heat treatment may decrease.

For example, the positive pressure of 10 Pa is a pressure higher than the atmospheric pressure by 10 Pa, and for example, when the atmospheric pressure is 101.3 kPa, the positive pressure refers to 101.31 kPa.

An atmosphere in the heat treatment furnace is not particularly limited, and may be an acidic atmosphere, a reducing atmosphere, or the like, and is preferably an inert atmosphere, more preferably an inert atmosphere having an oxygen volume concentration of 1500 ppm or less, still more preferably an inert atmosphere having an oxygen volume concentration of 200 ppm or more and 1000 ppm or less, and particularly preferably an inert atmosphere having an oxygen volume concentration of 300 ppm or more and 700 ppm or less. When the oxygen volume concentration in the inert atmosphere is within the above range, oxidation of the metal powder can be prevented more reliably. In addition, when an oxide film is formed, the stress strain may be less likely to be relaxed. In view of this, when the oxygen volume concentration is within the above range, the coercive force of the nanocrystalline alloy soft magnetic powder can be favorably reduced by the heat treatment.

Examples of the inert gas constituting the inert atmosphere include a nitrogen gas and an argon gas.

If necessary, an insulating film may be formed at a surface of each particle of the obtained nanocrystalline alloy soft magnetic powder. Examples of a constituent material of the insulating film include inorganic materials such as phosphates such as magnesium phosphate, calcium phosphate, zinc phosphate, manganese phosphate, and cadmium phosphate, and silicates such as sodium silicate, ceramic materials such as silica, alumina, magnesia, zirconia, and titania, and glass materials such as borosilicate glass and silica glass.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, a solenoid valve, and a generator. The dust core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is the magnetic element according to the embodiment, will be described.

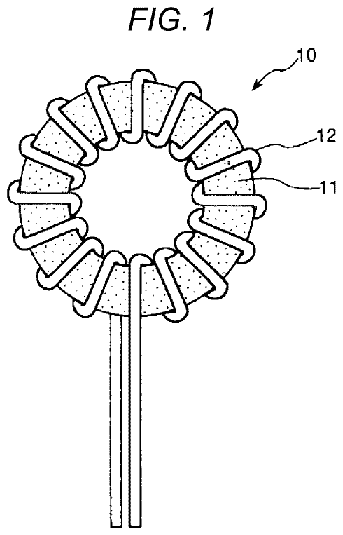

FIG. 1 is a plan view schematically showing a coil component 10 of a toroidal type. The coil component 10 shown in FIG. 1 includes a ring-shaped dust core 11 and a conductive wire 12 wound around the dust core 11.

The dust core 11 is obtained by mixing the nanocrystalline alloy soft magnetic powder according to the embodiment with a binder and compacting the obtained mixture. The dust core 11 is a green compact containing the nanocrystalline alloy soft magnetic powder according to the embodiment. Therefore, the coil component 10 having high permeability and low iron loss is obtained. When the coil component 10 is mounted on an electronic device or the like, high performance, miniaturization, and power saving of the electronic device or the like can be achieved.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material of the conductive wire 12 include a material having high conductivity, for example, a metal material including Cu, Al, Ag, Au, and Ni. An insulating film is provided on a surface of the conductive wire 12 as necessary.

A shape of the dust core 11 is not limited to the ring shape shown in FIG. 1, and may be, for example, a shape in which a part of the ring is missing, or a shape in which a shape in a longitudinal direction is linear.

The dust core 11 may contain, as necessary, a soft magnetic powder other than the nanocrystalline alloy soft magnetic powder according to the embodiment described above, or a non-magnetic powder.

### 3.2. Closed Magnetic Circuit Type

Next, a closed magnetic circuit type coil component, which is the magnetic element according to the embodiment, will be described.

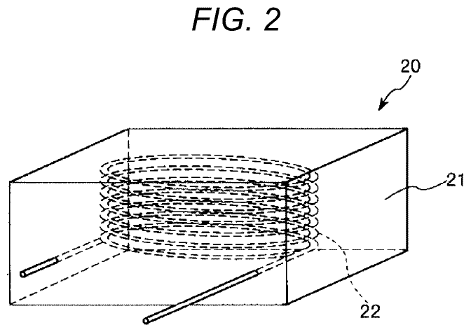

FIG. 2 is a transparent perspective view schematically showing a closed magnetic circuit type coil component 20.

Hereinafter, the closed magnetic circuit type coil component 20 will be described. In the following description, differences from the toroidal type coil component 10 will mainly be described, and description of similar matters will be omitted.

The coil component 20 shown in FIG. 2 is formed by embedding a conductive wire 22 formed in a coil-like shape inside a dust core 21. The dust core 21 is a green compact containing the nanocrystalline alloy soft magnetic powder according to the embodiment. Therefore, the coil component 20 having high permeability and low iron loss is obtained. Further, when the coil component 20 is mounted on an electronic device or the like, high performance, miniaturization, and power saving of the electronic device or the like can be achieved.

The dust core 21 may contain, as necessary, a soft magnetic powder other than the nanocrystalline alloy soft magnetic powder according to the embodiment described above, or a non-magnetic powder.

### 4. Electronic Device

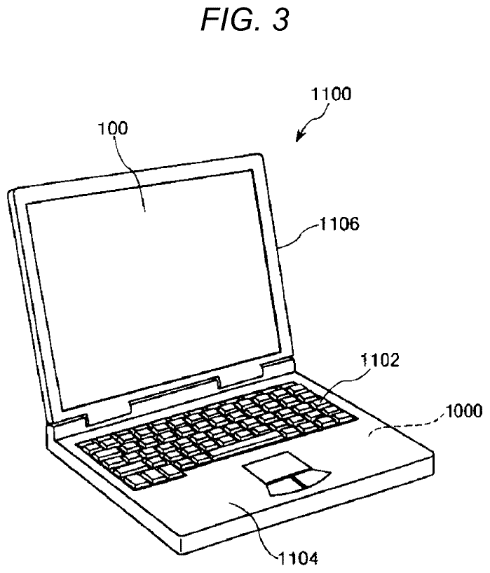

Next, the electronic device including the magnetic element according to the embodiment will be described with reference to FIGS. 3 to 5.

FIG. 3 is a perspective view showing a configuration of a mobile personal computer 1100 which is an electronic device according to the embodiment. The personal computer 1100 shown in FIG. 3 includes a main body 1104 including a keyboard 1102 and a display unit 1106 including a display 100. The display unit 1106 is pivotally supported by the main body 1104 via a hinge structure. Such the personal computer 1100 includes therein a magnetic element 1000 such as a choke coil, an inductor, or a motor for a switching power supply.

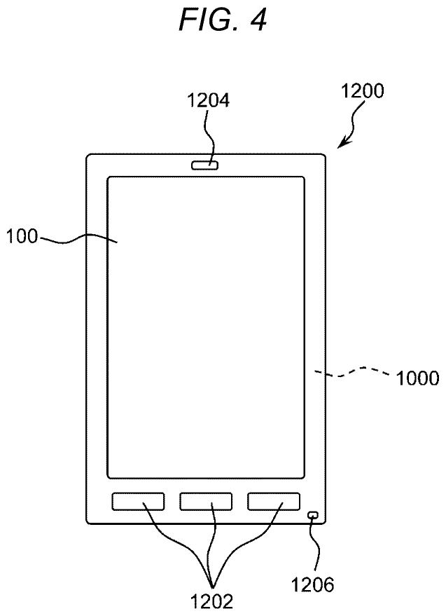

FIG. 4 is a plan view showing a configuration of a smartphone 1200 which is an electronic device according to the embodiment. The smartphone 1200 shown in FIG. 4 includes a plurality of operation buttons 1202, an earpiece 1204, and a mouthpiece 1206. In addition, the display 100 is disposed between the operation buttons 1202 and the earpiece 1204. Such the smartphone 1200 includes therein the magnetic element 1000 such as an inductor, a noise filter, or a motor.

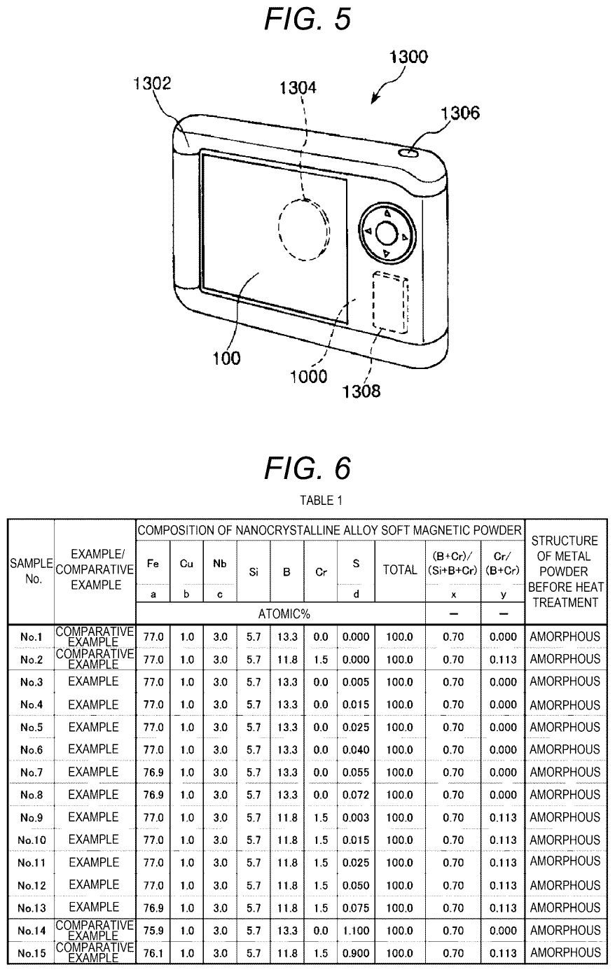

FIG. 5 is a perspective view showing a configuration of a digital still camera 1300 which is an electronic device according to the embodiment. The digital still camera 1300 photoelectrically converts an optical image of a subject with an imaging element such as a charge coupled device (CCD) to generate an imaging signal.

The digital still camera 1300 shown in FIG. 5 includes the display 100 provided at a rear surface of a case 1302. The display 100 functions as a finder that displays the subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such the digital still camera 1300 also includes therein the magnetic element 1000 such as an inductor or a noise filter.

Examples of the electronic device according to the embodiment include, in addition to the personal computer 1100 in FIG. 3, the smartphone 1200 in FIG. 4, and the digital still camera 1300 in FIG. 5, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

Such an electronic device includes the magnetic element according to the embodiment. Accordingly, effects of the magnetic element can be provided, and high performance, miniaturization, and power saving of the electronic device can be achieved.

### 5. Effects of Embodiment

As described above, the nanocrystalline alloy soft magnetic powder according to the embodiment contains: impurities; and a composition represented by a composition formula FeₐCu_{b}Nb_{c}(Si₁₋ₓ(B_{1-y}Cr_{y})ₓ)_{100-a-b-c-d}S_{d} represented by an atomic ratio, where a, b, c, d, x, and y satisfy 75.5≤a≤79.5, 0.3≤b≤2.0, 2.0≤c≤4.0, 0.001≤d≤0.080, 0.55≤x≤0.91, and 0≤y≤0.185, the nanocrystalline alloy soft magnetic powder has crystal grains having a crystallite diameter of 1.0 nm or more and 30.0 nm or less measured by an X-ray diffraction method, and in a volume-based cumulative particle size distribution obtained using a laser diffraction type particle size distribution measurement device, when D10 is a particle diameter at which a cumulative frequency is 10% from a small diameter side and D50 is a particle diameter at which a cumulative frequency is 50% from the small diameter side, the particle diameter D10 is 7.0 μm or more and 15.0 μm or less, and the particle diameter D50 is 22.0 μm or more and 32.0 μm or less.

According to such a configuration, a nanocrystalline alloy soft magnetic powder having an optimized particle shape and particle size distribution and exhibiting good filling properties and magnetic properties is obtained.

In the nanocrystalline alloy soft magnetic powder according to the embodiment, when a classified product that is obtained by classification using a first sieve having an opening of 53 μm and that passes through the first sieve is defined as −53 particles, and a classified product that is obtained by classifying the −53 particles using a second sieve having an opening of 25 μm and that passes through the second sieve is defined as −25 particles, a mass ratio of the −25 particles to the −53 particles is 40% or more and 65% or less.

According to such a configuration, since the mass ratio of the particles sandwiching the particle diameter of 25 μm can be optimized, the nanocrystalline alloy soft magnetic powder having particularly high fluidity and filling property is obtained.

In the nanocrystalline alloy soft magnetic powder according to the embodiment, in the cumulative particle size distribution, when a particle diameter at which the cumulative frequency is 90% from the small diameter side is defined as D90 and a ratio of the particle diameter D10 to the particle diameter D90 is defined as a particle diameter ratio D10/D90, the particle diameter ratio D10/D90 is preferably 0.180 or more and 0.220 or less.

According to such a configuration, since the particle size distribution can be optimized, the nanocrystalline alloy soft magnetic powder having high fluidity and filling property is obtained.

In the nanocrystalline alloy soft magnetic powder according to the embodiment, the tap density is preferably 4.90 g/cm³ or more and 5.20 g/cm³ or less.

According to such a configuration, a nanocrystalline alloy soft magnetic powder having particularly high fluidity and filling properties is obtained.

It is preferable that, when the nanocrystalline alloy soft magnetic powder according to the embodiment is mixed with an epoxy resin having a mass ratio of 2.0 mass %, and the obtained mixture is press-molded at a pressure of 294.2 MPa (3 t/cm²) to prepare a ring-shaped molded body having an outer diameter of 14 mm, an inner diameter of 8 mm, and a thickness of 3 mm, then a conductive wire having a wire diameter of 0.6 mm is wound around the molded body seven times to prepare a test object, and the iron loss Pi of the test object is measured at a maximum magnetic flux density of 50 mT and a measurement frequency of 900 kHz, the ratio D10/Pi of the particle diameter D10 to the iron loss Pi is 0.0011 (μm·kW)/m³ or more and 0.0020 (μm·kW)/m³ or less.

According to such a configuration, a nanocrystalline alloy soft magnetic powder capable of implementing a magnetic element having a high molding density of a dust core and a low iron loss is obtained.

In the nanocrystalline alloy soft magnetic powder according to the embodiment, an oxygen content is preferably 800 ppm or more and 3000 ppm or less in terms of mass ratio.

According to such a configuration, the formation of an oxide that causes a decrease in a density of a molded body can be particularly reduced to a low level, and insulating properties between particles associated with the oxide can be secured to some extent.

In the nanocrystalline alloy soft magnetic powder according to the embodiment, the average circularity is preferably 0.85 or more and less than 1.00.

According to such a configuration, since the particles of the nanocrystalline alloy soft magnetic powder are spheroidized, a filling state can be brought close to closest packing, and the ease of production can be enhanced.

The dust core according to the embodiment includes the nanocrystalline alloy soft magnetic powder according to the embodiment.

According to such a configuration, a dust core capable of implementing a magnetic element having high permeability and low iron loss is obtained.

The magnetic element according to the embodiment includes the dust core according to the embodiment.

According to such a configuration, a magnetic element having high permeability and low iron loss is obtained.

The electronic device according to the embodiment includes the magnetic element according to the embodiment.

According to such a configuration, it is possible to obtain an electronic device that achieves high performance, miniaturization, and power saving.

The nanocrystalline alloy soft magnetic powder, the dust core, the magnetic element, and the electronic device of the present disclosure are described above based on the preferred embodiment, and the present disclosure is not limited thereto.

For example, in the above embodiment, a green compact such as a dust core is described as an example of an application of the nanocrystalline alloy soft magnetic powder of the present disclosure, and the application example is not limited thereto, and may be, for example, a magnetic fluid and a magnetic device such as a magnetic head. In addition, shapes of the dust core and the magnetic element are not limited to those shown in the drawings, and any shapes may be adopted.

### EXAMPLES

Next, specific examples of the present disclosure will be described.

### 6. Preparation of Nanocrystalline Alloy Soft Magnetic Powder

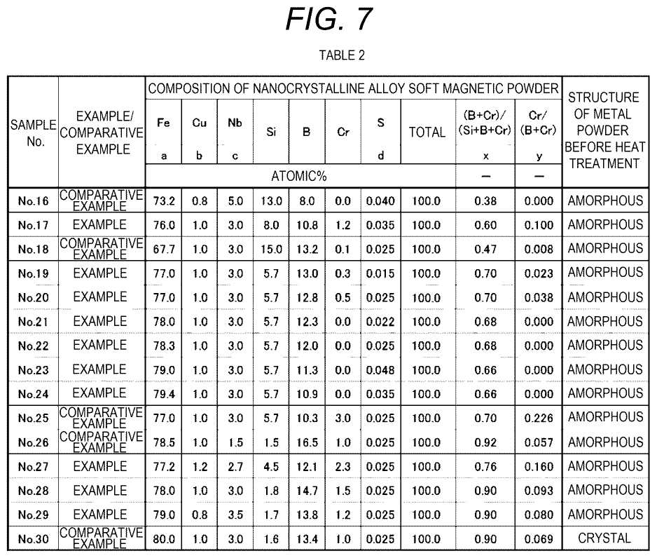

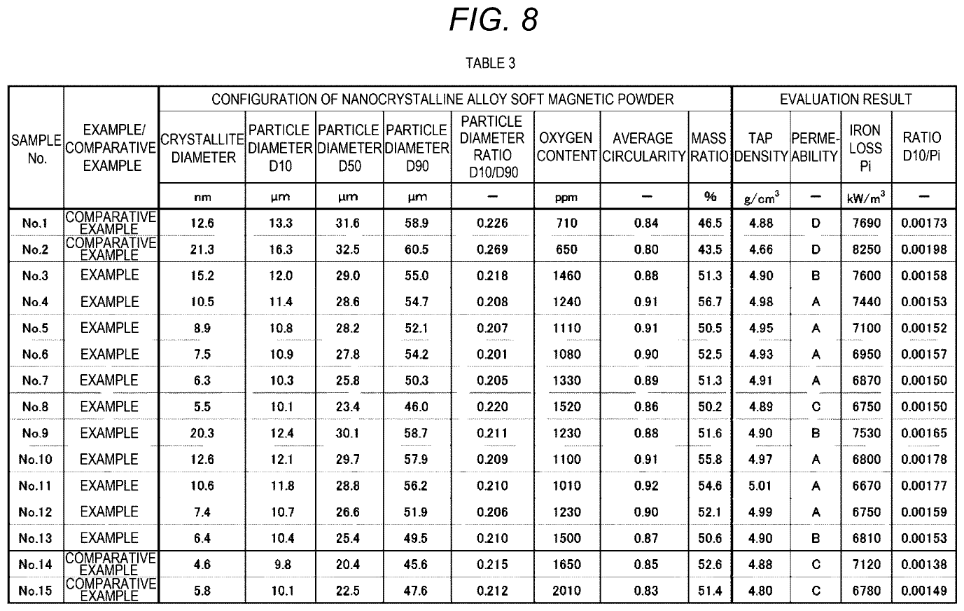

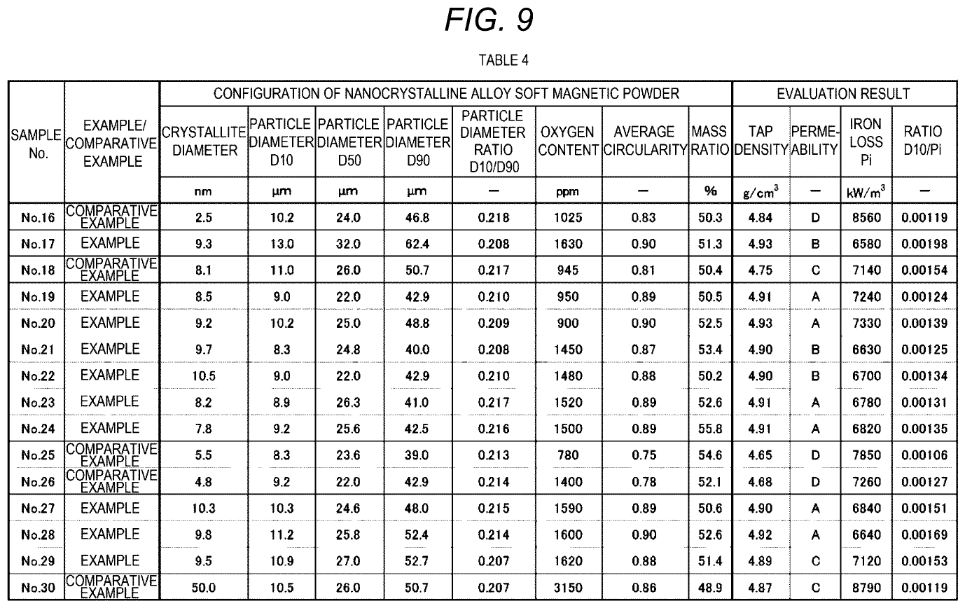

FIG. 6 is Table 1 showing configurations of the nanocrystalline alloy soft magnetic powders of sample Nos. 1 to 15. FIG. 7 is Table 2 showing the configurations of the nanocrystalline alloy soft magnetic powders of sample Nos. 16 to 30. FIG. 8 is Table 3 showing evaluation results of the nanocrystalline alloy soft magnetic powders of sample Nos. 1 to 15. FIG. 9 is Table 4 showing the evaluation results of the nanocrystalline alloy soft magnetic powders of sample Nos. 16 to 30.

### 6.1. Sample No. 1

First, a raw material was melted in a high frequency induction furnace and pulverized by a rotary water jet atomization method to obtain a metal powder. The obtained metal powder was classified with a sieve having an opening of 53 μm.

Then, the metal powder thus obtained was subjected to a heat treatment of performing heating in a nitrogen atmosphere. Conditions for the heat treatment were a heat treatment temperature of 570° C., a heat treatment time of 10 minutes, a positive pressure of 100 Pa, and an oxygen volume concentration in the furnace of 550 ppm.

As described above, a nanocrystalline alloy soft magnetic powder of Sample No. 1 was obtained. Table 1 (FIG. 6) shows the composition of the obtained nanocrystalline alloy soft magnetic powder and the structure of the metal powder before the heat treatment.

### 6.2. Sample Nos. 2 to 30

A nanocrystalline alloy soft magnetic powder was obtained in the same manner as in Sample No. 1 except that the production conditions of the nanocrystalline alloy soft magnetic powder were changed as shown in Table 1 (FIG. 6) or Table 2 (FIG. 7).

In Table 1 (FIG. 6) to Table 4 (FIG. 9), among the nanocrystalline alloy soft magnetic powders of the respective sample Nos., those corresponding to the present disclosure are “Examples”, and those not corresponding to the present disclosure are “Comparative Examples”.

### 7. Acquisition of Items Constituting Nanocrystalline Alloy Soft Magnetic Powder

### 7.1. Crystallite Diameter of Nanocrystalline Alloy Soft Magnetic Powder

The crystallite diameter of the nanocrystalline alloy soft magnetic powder of each of Examples and Comparative Examples was measured by an X-ray diffraction method. Measurement results are shown in Table 3 (FIG. 8) and Table 4 (FIG. 9).

### 7.2. Particle Diameter of Nanocrystalline Alloy Soft Magnetic Powder

For the nanocrystalline alloy soft magnetic powder of each of Examples and Comparative Examples, the particle diameter D10, the particle diameter D50, and the particle diameter D90 were measured. In addition, the particle diameter ratio D10/D90 was calculated. Measurement results and calculation results are shown in Tables 3 and 4.

### 7.3. Oxygen Content of Nanocrystalline Alloy Soft Magnetic Powder

The oxygen content of the nanocrystalline alloy soft magnetic powder of each of Examples and Comparative Examples was measured. The oxygen content was measured using an oxygen and nitrogen and hydrogen analyzer, ONH836, manufactured by LECO Corporation. The measurement results are shown in Tables 3 and 4.

### 7.4. Average Circularity of Nanocrystalline Alloy Soft Magnetic Powder

The average circularity of the nanocrystalline alloy soft magnetic powder of each of Examples and Comparative Examples was calculated. The calculation results are shown in Tables 3 and 4.

### 7.5. Mass Ratio of Nanocrystalline Alloy Soft Magnetic Powder

For the nanocrystalline alloy soft magnetic powder of each of Examples and Comparative Examples, the mass ratio of −25 particles to −53 particles was calculated. The calculation results are shown in Tables 3 and 4.

### 8. Evaluation Results of Nanocrystalline Alloy Soft Magnetic Powder

### 8.1. Tap Density of Nanocrystalline Alloy Soft Magnetic Powder

The tap density of the nanocrystalline alloy soft magnetic powder of each of Examples and Comparative Examples was measured. The measurement results are shown in Tables 3 and 4.

### 8.2. Permeability of Nanocrystalline Alloy Soft Magnetic Powder

The permeability of the nanocrystalline alloy soft magnetic powder of each of Examples and Comparative Examples was measured. Then, the obtained permeability was evaluated in view of the following evaluation criteria. Evaluation results are shown in Tables 3 and 4.
A: The permeability is 24 or more.
B: The permeability is 22 or more and less than 24.
C: The permeability is less than 22.

### 8.3. Iron Loss of Nanocrystalline Alloy Soft Magnetic Powder

The iron loss Pi was measured for the nanocrystalline alloy soft magnetic powder of each of Examples and Comparative Examples. The measurement results are shown in Tables 3 and 4.

The ratio D10/Pi of the particle diameter D10 to the iron loss Pi was calculated. The calculation results are shown in Tables 3 and 4.

As shown in Tables 3 and 4, it is found that the nanocrystalline alloy soft magnetic powder of each of Examples has a high tap density and high permeability. These evaluation results are considered to be due to the optimization of the particle shape and the particle size distribution of the nanocrystalline alloy soft magnetic powder of each of Examples, and good fluidity and filling properties.

In addition, it is found that the iron loss Pi can be reduced in a test object to be produced using the nanocrystalline alloy soft magnetic powder of each of Examples. This evaluation result is considered to be due to a low coercive force and reduction of the eddy current between the particles and in the particles in the nanocrystalline alloy soft magnetic powder of each of Examples.

What is claimed is:

1. A nanocrystalline alloy soft magnetic powder comprising:
impurities; and
a composition represented by a composition formula FeₐCu_{b}Nb_{c}(Si₁₋ₓ(B_{1-y}Cr_{y})ₓ)_{100-a-b-c-d}S_{d} represented by an atomic ratio, where a, b, c, d, x, and y satisfy 75.5≤a≤79.5, 0.3≤b≤2.0, 2.0≤c≤4.0, 0.001≤d≤0.080, 0.55≤x≤0.91, and 0≤y≤0.185, wherein
the nanocrystalline alloy soft magnetic powder has crystal grains having a crystallite diameter of 1.0 nm or more and 30.0 nm or less measured by an X-ray diffraction method, and
in a volume-based cumulative particle size distribution obtained using a laser diffraction type particle size distribution measurement device, when D10 is a particle diameter at which a cumulative frequency is 10% from a small diameter side and D50 is a particle diameter at which a cumulative frequency is 50% from the small diameter side, the particle diameter D10 is 7.0 μm or more and 15.0 μm or less, and the particle diameter D50 is 22.0 μm or more and 32.0 μm or less.

2. The nanocrystalline alloy soft magnetic powder according to claim 1, wherein
when a classified product that is obtained by classification using a first sieve having an opening of 53 μm and that passes through the first sieve is defined as −53 particles, and a classified product that is obtained by classifying the −53 particles using a second sieve having an opening of 25 μm and that passes through the second sieve is defined as −25 particles, a mass ratio of the −25 particles to the −53 particles is 40% or more and 65% or less.

3. The nanocrystalline alloy soft magnetic powder according to claim 1, wherein
in the cumulative particle size distribution, when D90 is a particle diameter at which the cumulative frequency is 90% from the small diameter side, and a ratio of the particle diameter D10 to the particle diameter D90 is defined as a particle diameter ratio D10/D90, the particle diameter ratio D10/D90 is 0.180 or more and 0.220 or less.

4. The nanocrystalline alloy soft magnetic powder according to claim 1, wherein
a tap density is 4.90 g/cm³ or more and 5.20 g/cm³ or less.

5. The nanocrystalline alloy soft magnetic powder according to claim 1, wherein
when the nanocrystalline alloy soft magnetic powder is mixed with an epoxy resin having a mass ratio of 2.0 mass %, and an obtained mixture is press-molded at a pressure of 294.2 MPa, which is 3 t/cm², to prepare a ring-shaped molded body having an outer diameter of 14 mm, an inner diameter of 8 mm, and a thickness of 3 mm, then a conductive wire having a wire diameter of 0.6 mm is wound around the molded body seven times to prepare a test object, and an iron loss Pi of the test object is measured at a maximum magnetic flux density of 50 mT and a measurement frequency of 900 kHz, a ratio D10/Pi of the particle diameter D10 to the iron loss Pi is 0.0011 (μm·kW)/m³ or more and 0.0020 (μm·kW)/m³ or less.

6. The nanocrystalline alloy soft magnetic powder according to claim 1, wherein
an oxygen content is 800 ppm or more and 3000 ppm or less in terms of mass ratio.

7. The nanocrystalline alloy soft magnetic powder according to claim 1, wherein
an average circularity is 0.85 or more and less than 1.00.

8. A dust core comprising:
the nanocrystalline alloy soft magnetic powder according to claim 1.

9. A magnetic element comprising:
the dust core according to claim 8.

10. An electronic device comprising:
the magnetic element according to claim 9.
